(19) United States
(12) Patent Application Publication
(10) Pub. No.: US 2017/0079478 A1
(43) Pub. Date: Mar. 23, 2017

(54) NITROUS OXIDE MIXTURES AND METHODS OF USE

(71) Applicant: KORVATA INC., Seattle, WA (US)

(72) Inventors: Warren R. Kirsch, Palo Alto, CA (US); Christian T. Metcalfe, Seattle, WA (US)

(21) Appl. No.: 15/125,434

(22) PCT Filed: Mar. 13, 2015
(86) PCT No.: PCT/US15/20522

§ 371 Date: Sep. 12, 2016

Related U.S. Application Data
(60) Provisional application No. 61/953,160, filed on Mar. 14, 2014.
(60) Provisional application No. 62/052,376, filed on Sep. 18, 2014.

(51) Int. Cl. A47J 43/12; A23L 2/54; B65B 7/16; B65B 31/00; B65D 83/30; B65D 85/72

(52) U.S. Cl. CPC A47J 43/12; B65D 83/30; B65D 85/72; B65B 7/16; B65B 31/003; A23L 2/54; A23V 2002/00

(57) ABSTRACT

A container having pressurized gas, the container includes an outlet, a liquid substance, a first gas dissolved in the liquid substance; and a noble gas. The liquid substance and the first gas are dispensed from the outlet when the container is oriented in a first position, and at least 90% of gas that is dispensed from the outlet when the container is oriented in a second position includes the noble gas.

### CLAIM OF PRIORITY

This application claims the benefit of the priority date of U.S. Provisional Patent Application No. 61/953,160, entitled “NITROUS OXIDE MIXTURES AND METHODS OF USE,” filed on Mar. 14, 2014, and the priority date of U. S. Provisional Patent Application No. 62/052,376, entitled “NITROUS OXIDE MIXTURES AND METHODS OF USE,” filed on Sep. 18, 2014. The entire contents of these provisional applications are herein incorporated by reference.

### TECHNICAL FIELD

This disclosure relates to nitrous oxide mixtures, including compositions, apparatus and methods of use. The disclosure features methods for reducing nitrous oxide emissions in food preparation that includes using nitrous oxide mixtures described herein.

### BACKGROUND

Nitrous oxide (also known as dinitrogen monoxide, N₂O or “laughing gas”) has been classified by the United Nations Intergovernmental Panel on Climate Change (IPCC) (http://www.ipcc.ch/pdf/assessment-report/ar4/wg1/ar4-wg1-spm.pdf) as a potent greenhouse gas with a Global Warming Potential (GWP) over 300 times that of carbon dioxide (CO₂). Nitrous oxide is the fourth most common greenhouse gas, behind water vapor, carbon dioxide and methane.

Nitrous oxide is persistent in the atmosphere on average for 120 years and reacts destructively with ozone in the stratosphere leading to a reduction in ultraviolet light absorption, such that more harmful ultraviolet light reaches the planet's surface (United States Environmental Protection Agency report EPA 430-R-10-001, “Methane and Nitrous Oxide Emissions from Natural Sources,” April 2010). Any reduction in the emissions of nitrous oxide will have significant positive long-term benefits to global habitability.

Compositions and methods used to reduce nitrous oxide emissions from human sources, such as in food preparation, can be beneficial. Nitrous oxide may be used to make whipped cream used as a topping for beverages and desserts.

An estimated 500 million 8-g nitrous oxide gas cartridges are used worldwide annually, resulting in the release of over 4 million metric tons of nitrous oxide (equivalent to 1.2 billion metric tons of carbon dioxide). Reducing the rate of release of nitrous oxide from these sources can have environmental benefit.

Nitrous oxide has also become a substance of abuse that is easy to obtain and difficult to detect. The huffing of nitrous oxide to achieve a narcotic high has become an abuse problem as reported in the public press (e.g., death as a result of nitrous oxide abuse, http://ktla.com/2013/05/21/popular-college-sophomore-dies-from-huffing-nitrous-oxide/) and by health organizations, for example, the National Institutes of Health (e.g., Nitrous Oxide Inhalation Among Adolescents: Prevalence, Correlates, and Co-Occurrence with Volatile Solvent Inhalation. J Psychoactive Drugs 2009; 41(4): 337-347).

### SUMMARY

In one aspect, a container includes pressurized gas, the container includes a liquid substance, a first gas dissolved in the liquid substance; and a noble gas. The first gas increases a volume of the liquid substance when the liquid substance is dispensed from the container. A total weight of the first gas within the container is between 0.1 to 9 times that of the noble gas; and a pressurized atmosphere within the container comprises less than 10% by weight of the first gas.

Implementations can include one or more of the following features. The liquid substance includes a diary product, and the first gas includes nitrous oxide. The dairy product includes cream and the noble gas includes argon. The pressurized gas within the container has a pressure that is between 100 to 300 psi. The noble gas includes xenon.

In another aspect, a container having pressurized gas, the container includes an outlet, a liquid substance, a first gas dissolved in the liquid substance, and a noble gas. The liquid substance and the first gas are dispensed from the outlet when the container is oriented in a first position. At least 90% of gas that is dispensed from the outlet when the container is oriented in a second position includes the noble gas.

Implementations can include one or more of the following features. The first position is an inverted position and the second position is an upright position. A pressurized atmosphere within the container includes less than 10% by weight of the first gas. The liquid substance includes cream, the first gas includes nitrous oxide and the noble gas includes argon.

In another aspect, a method of producing a pressurized container, the method includes introducing a liquid substance into the container, introducing a first gas into the container, the first gas dissolving in the liquid substance, introducing a noble gas into the container, providing an outlet to the container from which the liquid substance, the first gas, or the noble gas can be dispensed; and sealing the container to maintain a pressure of between 100 to 300 psi inside the container. The first gas increases a volume of the liquid substance upon dispensing of the liquid substance from the container. A total weight of the first gas within the container is between 0.1 to 9 times that of the noble gas; and a pressurized atmosphere within the container includes less than 10% by weight of the first gas.

Implementations include one or more of the following features. The liquid substance includes cream, the first gas includes nitrous oxide, and the noble gas includes argon. At least 90% of gas that is dispensed from the outlet when the pressurized container is oriented in a second position comprises argon.

In another aspect a gas cartridge includes a mixture of nitrous oxide and a noble gas; and an outlet of the gas cartridge is configured to engage with a receiving port of a pressurized dispenser. The mixture has a pressure of between 600 to 3000 psi within the gas cartridge, the gas cartridge having a capacity of less than 100 cubic centimeter (cc), and the pressurized dispenser is configured to contain a liquid substance in which nitrous oxide dissolves.

Implementations include one or more of the following features. The outlet is non-sealable. The outlet is sealable. The mixture includes 50% argon and 50% nitrous oxide. The noble gas includes xenon. An assembly includes the gas cartridge, and the pressurized dispenser. A pressure within the pressurized dispenser is between 100-300 psi after the mixture is released from the gas cartridge into the pressurized dispenser. The nitrous oxide from the mixture dissolves in the liquid substance and a pressurized atmosphere within the pressurizer dispenser includes less than 10% by weight of nitrous oxide. The mixture includes a food grade mixture. A method of using the assembly to aerate the liquid substance, the liquid substance includes a food product and the food product is aerated to a first volume that is within 50% of a volume of an aerated product that has been aerated with a 99% nitrous oxide gas composition.

One aspect of the current disclosure describes a composition including from about 10% to about 80% nitrous oxide by weight and one or more inert compounds that are gases at a temperature range of from about 0° C. to about 25° C. and at atmospheric pressure. In some embodiments, the composition includes from about 20% to about 80% nitrous oxide. In some embodiments, the composition includes from about 30% to about 80% nitrous oxide. In some embodiments, the composition includes from about 40% to about 80% nitrous oxide. In some embodiments, the composition includes from about 50% to about 80% nitrous oxide. In some embodiments, the composition includes from about 60% to about 80% nitrous oxide. In some embodiments, the composition includes from about 70% to about 80% nitrous oxide. Exemplary amounts of nitrous oxide present in the composition can be about 10%, 20%, 30%, 40%, 50%, 60%, 70%, or 80%.

In some embodiments, the one or more inert compounds is selected from: argon, helium, neon, krypton, xenon, nitrogen, and mixtures thereof. For example, the one or more inert compounds can include argon. In some embodiments, the one or more inert compounds can include xenon. The one or more inert gases can be about 20%, 30%, 40%, 50%, 60%, 70%, 80%, or 90% of the composition.

In some embodiments, the composition includes from about 40% to about 60% nitrous oxide by weight and one or more inert compounds selected from: argon, helium, neon, krypton, xenon, nitrogen, and mixtures thereof. For example, the composition can include about 40%, 50%, or 60% nitrous oxide. In some embodiments, the one or more inert compounds includes argon. In some embodiments, the one or more inert compounds includes xenon.

In some embodiments, the composition includes about 50% nitrous oxide and about 50% argon by weight.

In some embodiments, the composition includes about 50% nitrous oxide and about 50% xenon by weight.

In some embodiments, the composition is food grade.

In some embodiments, the mixture includes a liquid mixture. In some embodiments, the mixture includes a liquid/gas mixture. In some embodiments, the mixture includes a gas mixture.

In some embodiments, the composition is a pressurized composition. Such pressurized compositions may be formulated into gas canisters or aerosol cans. In some embodiments, the pressurized composition can be at a pressure from about 1.5 bar to about 450 bar. In some embodiments, the pressurized composition can be at a pressure from about 1.5 bar to about 50 bar. In some embodiments, the pressurized composition can be at a pressure from about 50 bar to about 100 bar. In some embodiments, the pressurized composition can be at a pressure from about 100 bar to about 150 bar. In some embodiments, the pressurized composition can be at a pressure from about 150 bar to about 200 bar. In some embodiments, the pressurized composition can be at a pressure from about 200 bar to about 250 bar. In some embodiments, the pressurized composition can be at a pressure from about 250 bar to about 300 bar. In some embodiments, the pressurized composition can be at a pressure from about 300 bar to about 350 bar. In some embodiments, the pressurized composition can be at a pressure from about 350 bar to about 400 bar. In some embodiments, the pressurized composition can be at a pressure from about 400 bar to about 450 bar.

An aspect of the present disclosure includes a method of aerating a food product with any of the compositions described herein.

In some embodiments, the food product includes a dairy product. In some embodiments, the dairy product is selected from milk, cream, and mixtures thereof.

In some embodiments, the food product includes a vegan non-dairy substitute of a dairy product. A number of vegan non-dairy substitutes can be used with the compositions and methods in this disclosure including almond milk, cashew milk, hazelnut milk, pistachio milk, oat milk, wheat milk, barley milk, millet milk, spelt milk, triticale milk, hemp milk, soy milk, rice milk, coconut milk, and mixtures thereof. For example, the food product can include almond milk. In some embodiments, the food product includes soy milk.

In some embodiments, the food product includes an oil. In some embodiments, the food product is selected from: canola oil, olive oil, peanut oil, vegetable oil, corn oil, coconut oil, palm oil, safflower oil, soybean oil, and mixtures thereof.

In some embodiments, the food product can be a mixture of any of the above. In a non-limiting example, the food product can be a mixture of a dairy product and a vegan non-dairy substitute, such as a mixture including about 90% whole milk and about 10% soy milk. Another example can be a food product which is a mixture of about 5% cream and about 95% coconut oil.

In some embodiments, the aerating results in an increased volume of the food product. In some embodiments, the volume increases by about 100%, 200%, 300%, 400%, or 500%.

In some embodiments, the aerated product using a composition of the present disclosure is comparable to that which has been aerated with a 99% nitrous oxide gas composition. In some embodiments, the volume reached by an aerated product using a composition of the current disclosure is within 50%, 40%, 30%, 20%, or 10% of an aerated product that has been aerated with a 99% nitrous oxide gas composition.

In some embodiments, the aerating with any of the compositions described herein has minimal effect on the flavor or aroma profile compared with an aerated product that has been aerated with a 99% nitrous oxide aerated gas composition.

A method of reducing nitrous oxide emissions is also disclosed, including substituting nitrous oxide with one or more inert gases by using any one of the compositions disclosed anywhere herein.

An aspect of this disclosure is a compressed gas cartridge including any of the compositions described herein.

An aspect of this disclosure is a compressed gas canister including any of the compositions described herein.

Also provided is a method for facilitating consumer acceptance of an aerated food product which has been aerated with any composition disclosed herein by reducing over a pre-determined time period the nitrous oxide content in a composition employed to aerate a food product from 99% nitrous oxide to the amount of nitrous oxide in any of the compositions described herein. In some embodiments, the pre-determined time period reduces the nitrous oxide content every three months. In some embodiments, the pre-determined time period reduces the nitrous oxide content every two months. In some embodiments, the pre-determined time period reduces the nitrous oxide content monthly. In some embodiments, the pre-determined time period reduces the nitrous oxide content every two weeks. In some embodiments, the pre-determined time period reduces the nitrous oxide content weekly.

Provided herein is a method of reducing the narcotic effect due to inhalation of a gaseous portion of a composition in a cartridge or a canister used to aerate a food product, including providing a cartridge or a canister including a composition as described herein. In some embodiments, the narcotic effect is reduced in a range from about 10% to about 70%. In some embodiments, the composition in the cartridge or the canister is capable of aerating a food product to a volume within 50% of an aerated product that has been aerated with a 99% nitrous oxide gas composition.

The composition as described herein exhibits a reduced narcotic effect compared with a composition including 99% nitrous oxide. In some embodiments, the narcotic effect is reduced in a range from about 10% to about 70%.

A compressed gas cartridge or a compressed gas canister as described herein includes a gas mixture, wherein inhalation of the mixture exhibits a reduced narcotic effect compared with a composition including 99% nitrous oxide. In some embodiments, the mixture is capable of aerating a food product to a volume within 50% of an aerated product that has been aerated with a 99% nitrous oxide gas composition.

Also provided herein is a method of reducing economic loss and/or liability due to unauthorized inhalation of a composition used to aerate a food product contained in a cartridge or a canister, including providing a cartridge or a canister including a composition as described herein.

### BRIEF DESCRIPTION OF THE DRAWINGS

FIG. 1A shows a schematic diagram of a container holding a liquid substance.

FIG. 1B shows a schematic view of an internal environment within the container of FIG. 1A.

FIG. 1C shows a schematic view of the container of FIG. 1A oriented in a first position.

FIG. 1D shows a schematic view of the container of FIG. 1A oriented in a second position.

FIG. 2A shows a schematic view of a dispenser.

FIG. 2B shows a schematic view of a gas cartridge.

### DETAILED DESCRIPTION

This disclosure provides compositions of nitrous oxide mixtures, and methods for using the same, including in food preparation to generate aerated food products. The compositions reduce the amount of nitrous oxide used to prepare an equivalent amount of aerated food product, while retaining aeration volume, flavor, and aroma profile. The mixtures and methods can reduce the amount of nitrous oxide emissions generated in the preparation of various products.

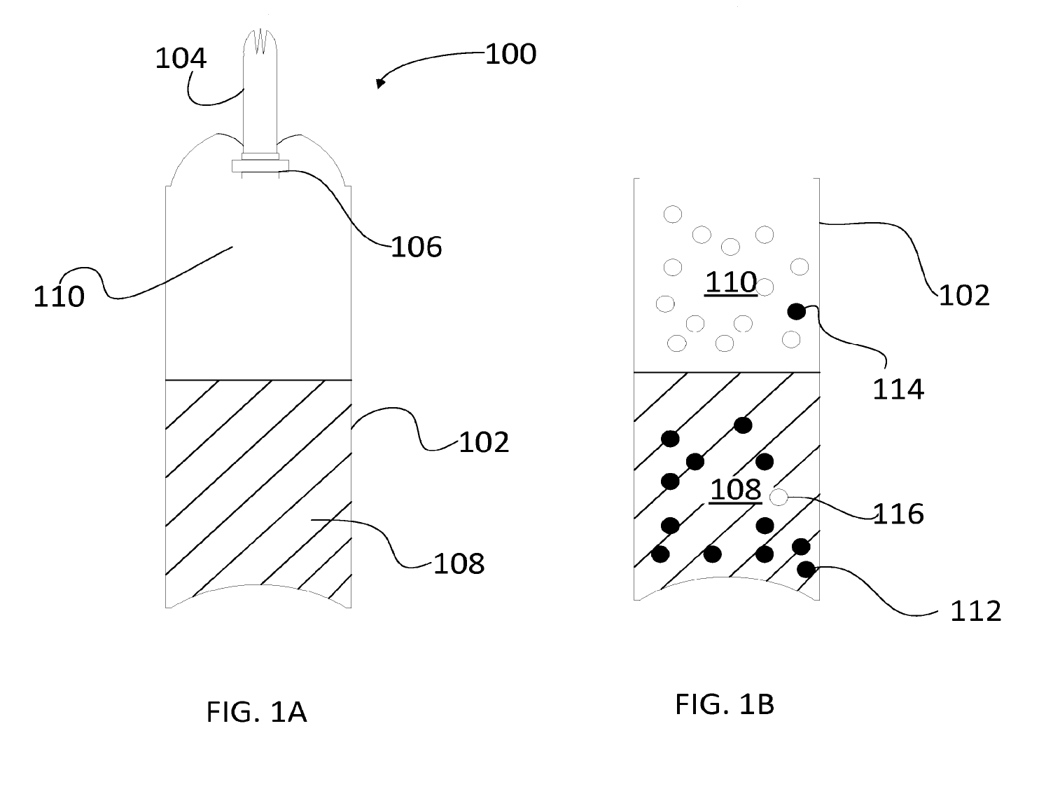

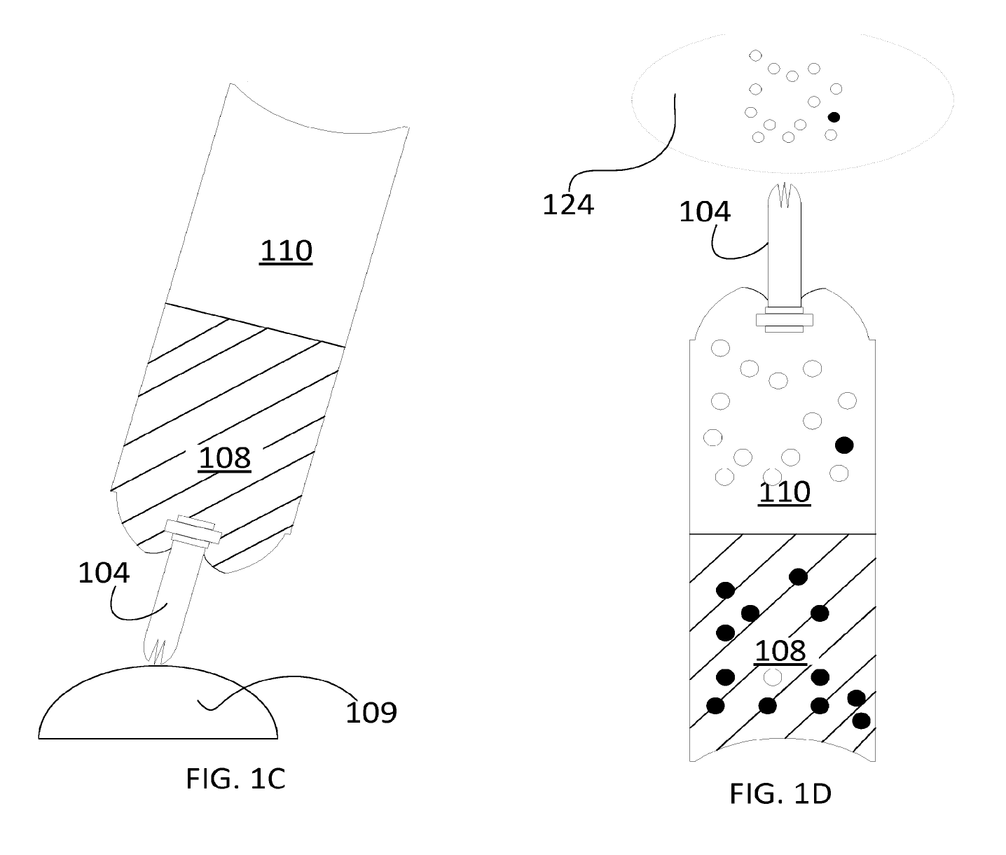

FIG. 1A shows a container 100 having a housing 102, an outlet 104 and a rim 106. The housing 102 defines an interior of the container 100. The interior can hold a liquid substance 108 and an internal atmosphere 110 adjacent to the liquid substance 108. The internal atmosphere 110 is a pressurized atmosphere. The container 100 dispenses the liquid substance 108 and/or a portion of the internal atmosphere 110 through the outlet 104. The outlet 104 can be a nozzle. The rim 106 allows the container 100 to maintain a pressurized atmosphere. The presence of the internal atmosphere 110 gives rise to the pressure within the container 100. In some embodiments, the container 100 is a pressurized container having an interior maintained at a pressure of between 100 psi to 300 psi. The container 100 can be a disposable container that is discarded after the liquid substance 108 has been discharged from the container. For example, the container can be a disposal aerosol can. The liquid substance 108 can include diary products such as cream, cheese, milk; food product such as cooking oil; or other chemicals such as hairspray.

FIG. 1B shows a first gas (represented by black dots) introduced into the interior of the container being partitioned into a first part 112 that is dissolved in the liquid substance 108, and a second part 114 that remains in the internal atmosphere 110 above the liquid substance when the container is oriented in an upright position, as shown in FIG. 1B. A second gas (represented by white dots) introduced into the interior of the container remains substantially in the internal atmosphere such that only a small portion 116 of the second gas is dissolved in the liquid substance 108. The first gas can be, for example, nitrous oxide, N₂O. Nitrous oxide is used in the production of a number of food products, such as, whipped dairy products for use in beverages like hot chocolate or coffee drinks, non-dairy whipped toppings for ice cream and desserts, cheese spray products, and cooking oil sprays.

The second gas can be, for example, a noble gas such argon, helium, xenon, neon, and krypton. Nitrous oxide has a lipid solubility at 25° C. and 36 psi of 7.08 g/L and a lipid solubility of 23.14 g/L at 25° C. and 36 psi. Argon, on the other hand, has a lower lipid solubility at 20° C. and 15 psi of 0.25 g/L and at 0° C. and 15 psi of 0.30 g/L.

The Bunsen Solubility Coefficients of nitrous oxide and the various noble gases in both water and olive oil are shown in Table 1 below. Nitrous oxide is more soluble in both lipids and water than many of the other gases.

TABLE 1
Solubility of gases in lipids vs. water

| | Bunsen solubility coefficient | Bunsen solubility |
|---|---|---|
| Gas | in olive oil | coefficient in water |
| He | 0.015 | 0.074 |
| Ne | — | 0.086 |
| Ar | 0.015 | 0.260 |
| Kr | 0.044 | 0.462 |
| N₂O | 1.56 | 47.6 |
| Xe | 1.90 | 9.9 |

In some embodiments, the liquid substance 108 contains lipids (e.g., the liquid substance 108 is cream), the first gas is nitrous oxide, and the second gas is argon. When both nitrous oxide and argon are introduced into the container 100, a significant portion of nitrous oxide (e.g., more than 50% of the introduced nitrous oxide, more than 60%, more than 70%, more than 80%, more than 90%, more than 95%, more than 99%) dissolves in the cream, and the remaining portion of the nitrous oxide (e.g., less than 50% of the introduced nitrous oxide, less than 40%, less than 30%, less than 20%, less than 10%, less than 5%, less than 1%) is retained in the internal atmosphere 110 adjacent the cream.

On the other hand, a significant portion of the argon remains in the internal atmosphere 110 (e.g., more than 80% of the introduced argon, more than 90%, more than 95%, more than 99%) because argon is not readily soluble in cream (e.g., less than 20% of the introduced argon is dissolved in cream, less than 10%, less than 5%, less than 1%).

When argon and nitrous oxide are introduced into the container 100, partitioning of argon and nitrous oxide between the internal atmosphere and the cream occurs under the pressurized atmosphere (e.g., between 100-300 psi) of the container. As a result, the internal atmosphere 110 of the container 100 has different percentages of argon and nitrous oxide compared to the weight percentage that was introduced into the container 100. For example, the internal atmosphere can contain less than 10% (by weight) of nitrous oxide and 90% (by weight) or more of argon when equal weight amounts (i.e., 50% by weight of argon and 50% by weight of nitrous oxide) are first introduced into the container 100. The pressure within the container 100 causes the nitrous oxide to become dissolved in the cream, to form a matrix of cream and small dissolved gas bubbles of nitrous oxide.

FIG. 1C shows the container 100 oriented in a first position, an inverted position. The container can dispense liquid substance 108 in the inverted position. In this position, the internal atmosphere 110 acts as a propellant to push the liquid substance 108, which contains dissolved first gas from the outlet 104 into an external environment to form an expanded substance 109. When the liquid substance 108 is cream, the expanded substance 109 is whipped cream. The first gas, which is dissolved in the liquid substance 108, expands rapidly when it is exposed to the external environment (e.g., maintained at atmospheric pressure). The small bubbles of first gas contained in the matrix of the liquid substance (e.g., cream) expands to become larger bubbles, and in the process increases the volume of the liquid substance. In other words, the first gas aerates and increases the volume of the liquid substance 108. When liquid substance 108 is a cream, and the first gas is nitrous oxide, the nitrous oxide aerates the cream as it is discharged from the container 100, and forms whipped cream.

FIG. 1D shows the container 100 oriented in a second position, an upright position. The container 100 does not dispense liquid substance 108 in the upright position. Rather, when container 100 is triggered to dispense its content (e.g., by applying pressure on the outlet 104), a gas mixture 122 that is a portion of the internal atmosphere 110 is released. Due to the partitioning of the first gas and second gas between the liquid substance and the internal atmosphere, even when equal weight amounts of first and second gases are introduced into the container 100, a different weight percentage or ratio of the two gases can form in the internal atmosphere. For example, the internal atmosphere 110 can be predominantly the second gas (e.g., more than 50% by weight of the gas released from the internal atmosphere 110 is the second gas, more than 60%, more than 70%, more than 80%, more than 90%, more than 95%, more than 99%) even when equal weight percentages of the first and second gases were introduced into the container. When the first gas is nitrous oxide and the second gas is argon, the gas mixture 122 can contain less than 10% (by weight) of nitrous oxide and 90% (by weight) or more of argon when equal weight amounts (i.e., 50% by weight of argon and 50% by weight of nitrous oxide) are first introduced into the container 100.

Instead of using only the first gas, which is soluble in the liquid substance, for both aerating the liquid substance and for propelling the liquid substance out of the container, a gas mixture 122 composed predominantly of a noble gas can be used as the propellant. When the first gas is nitrous oxide, the noble gas can serve as a replacement gas for nitrous oxide to provide the propellant functions of nitrous oxide. Similarly, gases that are of comparable lipid solubility as nitrous oxide may serve as replacements for the expansion and/or propellant function of nitrous oxide.

Such a replacement may be desirable to prevent nitrous oxide from being used to generate a huffing narcotic effect. For example, when nitrous oxide is used as the only gas in the container for aerating and propelling the liquid substance, releasing the contents of the container while it is held in an upright position can result in the discharge of only nitrous oxide (and no liquid substance).

Gases which do not have similar lipid solubility as nitrous oxide may serve to replace the propellant qualities of nitrous oxide. The Relative Narcotic Potency of some inert gases are shown in Table 2. The Relative Narcotic Potency (RNP) of various noble gases can serve as a surrogate for lipid solubility, as compared with nitrogen which has been standardized to have a value of 1.0 (see, for example, Ostlund, et al. J. Applied Physiology, 1994 January; 76(1): p. 439-44, and Nitrogen Narcosis from Wikipedia: http://en.wikipedia.org/wiki/Nitrogen_narcosis (accessed May 16, 2014)). Since nitrous oxide is a colorless, odorless gas, its abuse as a narcotic substance can be difficult to detect. Anecdotal evidence suggests that as many as one-third of the several hundred million 8-gram nitrous oxide cartridges sold annually may be used to produce the huffing narcotic effect. The abuse of nitrous oxide has been noted in several publications, e.g., Nitrous Oxide Inhalation Among Adolescents: Prevalence, Correlates, and Co-Occurrence with Volatile Solvent Inhalation. J Psychoactive Drugs 2009; 41(4): 337-347.

TABLE 2
Relative Narcotic Potency of some gases

| Gas | RNP |
|---|---|
| He | 0.045 |
| Ne | 0.3 |
| Ar | 2.3 |
| Kr | 7.1 |
| Xe | 25.6 |
| N₂O | 39 |

(from Journal of Applied Physiology 1994; 76(1): 439-444.) The reduction of nitrous oxide may offer a significant reduction in the abuse of nitrous oxide as a narcotic gas from, for example, inhalation of the gas from gas cartridges and canisters.

In some embodiments, the container 100 can be a 6.5-ounce aerosol can containing cream or a whipped topping formula, about 6 grams of nitrous oxide and about 6 grams of one or more noble gases. The amount of nitrous oxide dispensed in the second position, by holding the can with its outlet 104 (e.g., nozzle) upright can be reduced by an estimated 90% (e.g., at least 50%, at least 60%, at least 70%, at least 80%, at least 90%, at least 95%, at least 99%), compared with an aerosol can that contains only nitrous oxide. Most of the nitrous oxide from the mixture (6 gram of nitrous oxide and 6 grams of noble gases) is dissolved in the lipid and water phases of the whipped topping formula. Noble gases do not readily dissolve in the whipped topping formula, and would be in the internal atmosphere 110 adjacent the whipped topping formula within the can.

When an attempt is made to dispense the contents of the can by holding the can upright, the dispensed gas mixture 124 includes mostly the one or more noble gas compounds and an estimated amount of about 10% nitrous oxide (about 2%, about 5%, about 10%, about 20%). Due to the high solubility of the nitrous oxide in the liquid substance (e.g., whipped topping formula) relative to the one or more noble gas compounds also present in the gas mixture, such gas mixtures are less likely to be abused because of the much lower content of nitrous oxide in the gas mixture 124 dispensed from the can when held in an upright position compared to a can containing only nitrous oxide.

Furthermore, the nitrous oxide narcotic effect obeys a relationship between the log of the dose and the corresponding pharmacological response. For example, by reducing the dose of nitrous oxide is reduced by about 50%, the pharmacological effects, including a narcotic high, would be reduced by about 30% (the log of the dose reduction). Such a reduction in the narcotic effect may lead to a concomitant reduction in the other toxic effects of the abuse of nitrous oxide gas, up to and including death.

The compositions of the present disclosure can reduce nitrous oxide abuse by reducing the amount of narcotic gas (i.e., nitrous oxide) being used to produce an aerated food product. The replacement of nitrous oxide with one or more of the gases shown in Table 2 would reduce the relative narcotic potency of the resulting gas composition, and can decrease its potential for abuse.

The use of a gas mixture can reduce the narcotic effect due to inhalation of the gas mixture 124 discharged from a can used to aerate a food product. In some embodiments, the narcotic effect is reduced by an amount in a range from about 10% to about 70%. In some embodiments, the narcotic effect is reduced by about 10%, about 20%, about 30%, about 40%, about 50%, about 60%, or about 70%.

The use of the nitrous oxide-noble gas mixtures can reduce economic loss and/or liability due to unauthorized inhalation of nitrous oxide used to aerate a food product.

Producing the pressurized container 100 can include first introducing the liquid substance 108 into the container 100, introducing the first gas into the container which dissolves in the liquid substance. A noble gas can be introduced into the container at the same time, before, or after the first gas. Producing the pressurized container 100 includes providing an outlet 104 to the container 100, the outlet allowing the liquid substance, the first gas, or the noble gas to be dispensed from the container 100. The outlet 104 can be a nozzle. Thereafter, the container is sealed, for example, using a crimp seal, to maintain a pressure of between 100 to 300 psi in an interior of the container. The first gas increases a volume of the liquid substance upon dispensing of the liquid substance from the container. A total weight of the first gas within the container is between 0.1 to 9 times that of the noble gas; and a pressurized atmosphere within the container comprises less than 10% by weight of the first gas.

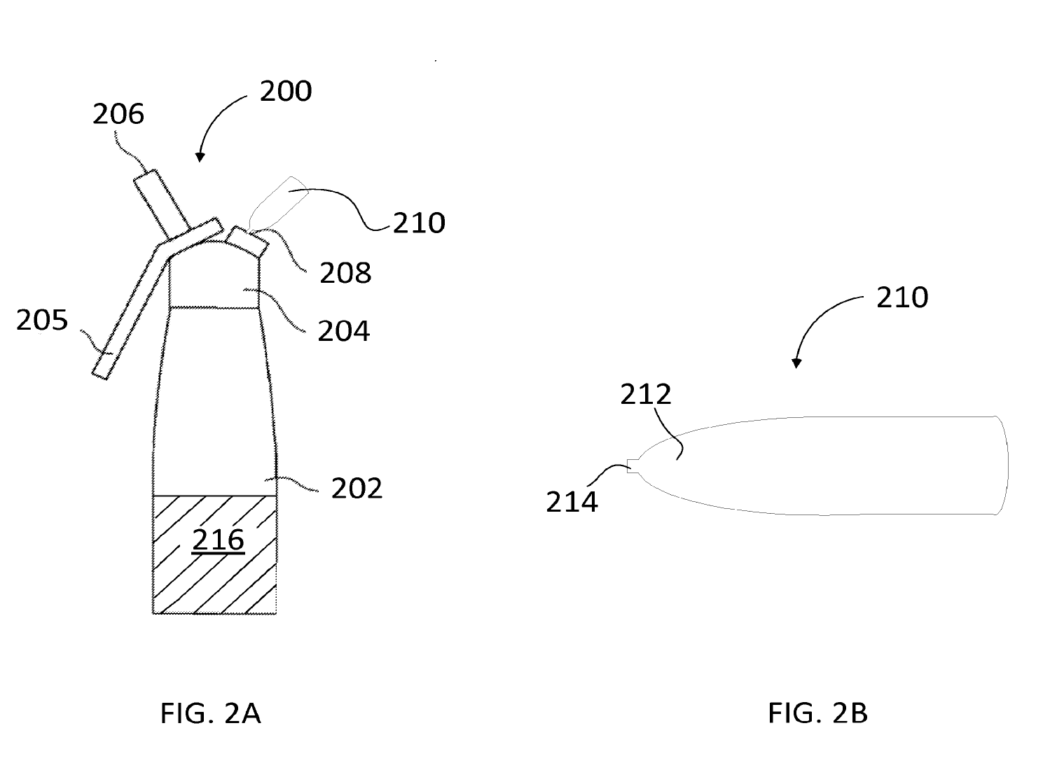

FIG. 2A shows a pressurized food dispensing assembly 200. The assembly 200 includes a food dispenser body 202, which can be made of stainless steel. The food dispenser body is fitted with a cap adapter 204 having an outlet 204 through which aerated food substance can be dispensed when a lever 205 is pressed. The cap adapter 204 can have a threaded connection for engaging with the food dispenser body 202. The cap adapter 204 includes a receiving port 208 which is configured to engage with a gas cartridge 210. A food product contained in the food dispenser body 202 can be aerated using the gas cartridge 210. The gas cartridge 210 has an internal volume that is less than 100 cubic centimeters (cc) and a pressure of between 300-6000 psi.

Instead of charging the pressurized food dispensing assembly 200 with a gas cartridge containing only nitrous oxide (e.g., an 8-g nitrous oxide compressed gas cartridge), a gas cartridge having a mixture of gases can be used. In some embodiments, the gas cartridge 210 can contain a 50% nitrous oxide-50% noble gas mixture (e.g., 4-g of nitrous oxide and 4-g of argon).

The gas cartridge 210 can have similar dimensions as commercially available gas cartridges, such as 8-g threaded or unthreaded cylindrical stainless steel gas cartridges. For example, a compressed gas cartridge including any of the compositions described herein can be a pressurized composition of about 420 bar.

The gas cartridge 210 has a narrow portion 212 configured to engaged with the receiving port 208. The narrow portion 212 contains a seal 214. Seal 214 can be a non-sealable seal which is punctured when the gas cartridge 210 is engaged to the food dispenser body. The gas mixture in gas cartridge 210 exits the cartridge through the broken seal 214 and pressurizes an internal atmosphere of the food dispenser body 202 to between 100-300 psi.

Instead of disposing the spent gas cartridge after the gas mixture has been discharged into the food dispenser body, the seal 214 can also be a resealable such that the gas cartridge can be refilled and reused. Such a resealable seal can include a valve whose valve plunger is displaceable for valve opening. The valve plunger can have a valve passage that is used to introduce the gas mixture into the gas cartridge.

The food dispenser body 202 can hold a food product 216 having a water phase and a lipid phase (e.g., cream, for whipping top formulation). The gas cartridge 210 is engaged with the receiving port 208 after the food product 216 (e.g., heavy whipped cream) has been introduced into the food dispenser body 202. The receiving port 208 of the cap adapter 204 contains mechanism to either puncture a non-sealable seal of the gas cartridge or to operate a resealable seal of the gas cartridge in order for the gas mixture to be discharged from the gas cartridge.

Once the gas mixture enters the pressurized interior of the food dispenser body 202, partition of the gas mixture within the internal atmosphere, the water phase and the liquid phase of the food product occurs. In the case of a gas mixture containing 50% by weight of nitrous oxide, and 50% by weight of a noble gas (e.g., argon), the internal atmosphere 216 adjacent to the food product can contain a significantly larger percentage by weight of the noble gas (e.g., at least 60%, at least 70%, at least 80%, at least 90%, at least 95%, at least 99%) and a significantly smaller percentage of nitrous oxide (e.g., less than 40%, less than 30%, less than 20%, less than 10%, less than 5%, less than 1%). The nitrous oxide is preferentially dissolved or absorbed by the water phase and the lipid phase of the food product.

The gas cartridge 214 can be a 10-cc mixed gas, industry-standard 8-g cartridge containing an amount of gas in the range of from about 1 to about 7 grams of nitrous oxide, and one or more of the inert gases (e.g., argon, carbon dioxide, helium, hydrogen, krypton, neon, nitrogen, oxygen, and/or xenon) in a range of from about 7 to about 1 grams. By example, an 8-g cartridge can contain about 4 grams of nitrous oxide (molecular weight 44 g/mol) and about 4 grams of argon (molecular weight 40 g/mol), with the two gases being in approximately equal molar concentrations. Accordingly, the replacement of 4 grams of nitrous oxide with 4 grams of argon in a gas cartridge of the present disclosure constitutes a 50% reduction in the nitrous oxide content of the gas cartridge of the disclosure compared to an 8-g cartridge including only nitrous oxide.

Alternatively, the food dispenser 202 can be charged sequentially to its full pressure using a first gas cartridge containing only nitrous oxide (e.g., a 4-g nitrous oxide cartridge) and then charged with a second gas cartridge containing only the noble gas (e.g., a 4-g argon cartridge or a 4-g xenon cartridge). This approach may offer significant environmental benefits due to the reduction in the use of nitrous oxide. Other ratios of nitrous oxide and noble gases are possible. For example, the food dispenser body 202 can be charged using a 2-g nitrous oxide cartridge, then a 6-g xenon cartridge to the full pressure. In this way, a gas mixture having about 25% nitrous oxide and about 75% xenon at full pressure is introduced into the food dispenser body 202.

The components of nitrous oxide and the one or more noble gas compounds that are gases at a temperature range of from about 0° C. to about 25° C. and at atmospheric pressure may be in, for example, two, three, four or five gas cartridges, and may be combined in a single chamber prior to aerating the food product. Two partially filled gas cartridges can also be used to charge fully the food dispenser body 202.

In some embodiments, the gas cartridge may be a dual compartment cartridge that contains two chambers, with one containing nitrous oxide and the other containing one or more inert compounds that are gases at a temperature range of from about 0° C. to about 25° C. and at atmospheric pressure. In some embodiments, the one or more inert compounds is selected from argon, helium, neon, krypton, xenon, nitrogen, and mixtures thereof. For example, the one or more inert compounds can be argon. In some embodiments, the one or more inert compounds is xenon. The dual compartment cartridge allows for the formation of any of the compositions described herein with the use of a single gas cartridge.

### Methods

The present application discloses methods for reducing nitrous oxide emissions in food preparation using any of the compositions described herein to prepare an aerated food product. The compositions and methods can be used in, for example, the generation of aerated food products, such as whipped cream, without compromising product quality. The proportions of nitrous oxide and one or more inert compounds significantly reduce the level of nitrous oxide emissions while retaining the useful characteristics of pure nitrous oxide gas. In one non-limiting example, a coffee shop can reduce its yearly emissions of nitrous oxide by replacing the food-grade nitrous oxide used in preparing whipped cream toppings for mochas and other hot drinks with a composition including about 50% nitrous oxide and about 50% argon. In another non-limiting example, a coffee shop can reduce its yearly emissions of nitrous oxide by replacing the food-grade nitrous oxide used in preparing whipped cream toppings for mochas and other hot drinks with a composition including about 50% nitrous oxide and about 50% xenon.

An aspect of the present disclosure includes a method of aerating a food product with any of the compositions described herein.

A number of aerated food products are packaged in aerosol spray cans. These food products include whipped cream toppings for desserts, cheese spray products, and aerosol oil sprays, for example, olive oil that can be sprayed onto a cooking pan. The aerosol cans typically contain food-grade nitrous oxide in order to propel and/or expand the product from the can. The use of a composition of the present disclosure would reduce the amount of nitrous oxide needed on a per aerosol can basis to achieve a product with similar characteristics, thereby reducing the amount of nitrous oxide emissions with equivalent use.

Coffee shops, for example, dispense whipped cream as toppings for hot drinks, such as on hot chocolate or mocha drinks A coffee shop worker typically dispenses the whipped cream from an aerosol can containing whipped cream or a refillable stainless steel cream whip dispenser. The whipped cream is expelled out of each of these using nitrous oxide gas, either from the aerosol can, or from a gas cartridge mounted on the cream whip dispenser. The nitrous oxide mixtures of the present disclosure can be used to replace the food-grade nitrous oxide currently used, and thus allow an establishment to reduce its overall contribution toward global warming by reducing its rate of emissions of the greenhouse gas nitrous oxide over a period of time.

In some embodiments, the food product includes a dairy product, which may be from cows, goats, sheep or mixtures thereof. For example, the dairy product can be milk (e.g. skim milk, 1% lowfat milk, 2% lowfat milk, or whole milk), cream (typically 8% butterfat or greater, such as 16% butterfat or 36% butter fat), or any mixture thereof (e.g. half and half).

Some customers who may not consume dairy due to allergy or other dietary reasons may want a vegan non-dairy substitute. In some embodiments, the food product is a vegan non-dairy substitute of a dairy product. A number of vegan non-dairy substitutes can be used with the compositions and methods in this disclosure including almond milk, cashew milk, hazelnut milk, pistachio milk, oat milk, wheat milk, barley milk, millet milk, spelt milk, triticale milk, hemp milk, soy milk, rice milk, coconut milk, and mixtures thereof. For example, the food product can include almond milk. In some embodiments, the food product includes soy milk.

Other non-dairy substitutes include non-dairy creamers made from plant-based oils. In some embodiments, the food product includes an oil. Such oils may be aerated to produce, for example, non-dairy whipped toppings. Oils may also be used in cooking, and may be packaged, for example, in aerosol spray cans. The aerosol cans commonly contain nitrous oxide as a propellant. Use of the presently disclosed nitrous oxide mixtures would reduce the overall nitrous oxide emissions resulting from food-grade aerosol cans. In some embodiments, food products that may be used in compositions and methods of the current disclosure include canola oil, olive oil, peanut oil, vegetable oil, corn oil, coconut oil, palm oil, safflower oil, soybean oil, and mixtures thereof.

In some embodiments, one or more flavorings are added to the food product. In some embodiments, the one or more flavorings do not affect the ability of the food product to be aerated to a similar extent as the food product without the one or more flavorings. By example, whipped cream toppings often have a small amount of vanilla flavoring added that does not significantly affect the ability for the cream to be whipped. In some embodiments, the one or more flavorings include natural flavorings. In some embodiments, the one or more flavorings are selected from vanilla, chocolate, hazelnut, amaretto, rum, raspberry, and blackberry. For example, the one or more flavorings can be vanilla.

In some embodiments, the aerating results in an increased volume of the food product. In some embodiments, the volume increases by about 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, 300%, 310%, 320%, 330%, 340%, 350%, 360%, 370%, 380%, 390%, 400%, 410%, 420%, 430%, 440%, 450%, 460%, 470%, 480%, 490%, or 500%.

In some embodiments, the aerated product using a composition of the present disclosure has features that are comparable to one which has been aerated with a 99% nitrous oxide gas composition. In some embodiments, the volume reached by an aerated product using a composition of the current disclosure is within 50%, 40%, 30%, 20%, or 10% of an aerated product that has been aerated with a 99% nitrous oxide gas composition. Volumes may be measured by any number of methods, for example, in graduated measuring cups or volumetric flasks.

The volumes of the aerated product using a composition of the present disclosure and that using a 99% nitrous oxide gas composition may be compared at specific time intervals. For example, the volumes of the two aerated products may be compared upon dispensing (time 0), after 10, 20, 30, or 45 minutes, or after 1, 2, 3, 4, 5, 6, 9, 12, 18, or 24 hours. Thus not only the volumes dispensed may be compared, but also the collapse time. The collapse time measures the amount of time elapsed after initial dispensation of an aerated product in comparison to an aerated volume. For example, a collapse time of 6 hours can be measured for an amount of whipped cream to reach 75% by volume compared to initial volume at dispensation. In some embodiments, the collapse time of an aerated product using a composition of the current disclosure is within 50%, 40%, 30%, 20%, or 10% of time elapsed compared to an aerated product that has been aerated with a 99% nitrous oxide gas composition.

Product quality may be determined in tasting and sensory panels, for example, comparing the product made from the composition and methods of the current disclosure to those made with nitrous oxide alone. Such panels typically perform tasting comparisons as well as sensory comparisons, for instance, mouthfeel or visual appeal between products. In some embodiments, the aerating with any of the compositions described herein has minimal effect on the flavor or aroma profile compared with an aerated product that has been aerated with a 99% nitrous oxide aerated gas composition.

Also provided is a method for facilitating consumer acceptance of an aerated food product which has been aerated with any composition disclosed herein by reducing over a pre-determined time period the nitrous oxide content in a composition employed to aerate a food product from 99% nitrous oxide to the amount of nitrous oxide in any of the compositions described herein. The reduction may be done in a methodical, stepwise fashion to facilitate consumer acceptance. In some embodiments, the pre-determined time period reduces the nitrous oxide content every three months. In some embodiments, the pre-determined time period reduces the nitrous oxide content every two months. In some embodiments, the pre-determined time period reduces the nitrous oxide content monthly. In some embodiments, the pre-determined time period reduces the nitrous oxide content every two weeks. In some embodiments, the pre-determined time period reduces the nitrous oxide content weekly. In a non-limiting example, a food provider may reduce the level of nitrous oxide in a composition used to produce whipped cream by decreasing the nitrous oxide content by 10% in the composition each month for five months until a composition including 50% nitrous oxide is reached, to reassure consumers that there are minimal differences between the aerated food product using 99% nitrous oxide and one using a composition including 50% nitrous oxide.

Compositions

One aspect of the current disclosure describes a composition including from about 10% to about 80% nitrous oxide by weight and one or more inert compounds that are gases at a temperature range of from about 0° C. to about 25° C. and at atmospheric pressure. In some embodiments, the composition includes from about 20% to about 80% nitrous oxide. In some embodiments, the composition includes from about 30% to about 80% nitrous oxide. In some embodiments, the composition includes from about 40% to about 80% nitrous oxide. In some embodiments, the composition includes from about 50% to about 80% nitrous oxide. In some embodiments, the composition includes from about 60% to about 80% nitrous oxide. In some embodiments, the composition includes from about 70% to about 80% nitrous oxide. In some embodiments, a composition consists essentially of from about 10% to about 80% nitrous oxide and one or more inert compounds that are gases at a temperature range of from about 0° C. to about 25° C. and at atmospheric pressure. In some embodiments, the composition consists essentially of from about 20% to about 80% nitrous oxide. In some embodiments, the composition consists essentially of from about 30% to about 80% nitrous oxide. In some embodiments, the composition consists essentially of from about 40% to about 80% nitrous oxide. In some embodiments, the composition consists essentially of from about 50% to about 80% nitrous oxide. In some embodiments, the composition consists essentially of from about 60% to about 80% nitrous oxide. In some embodiments, the composition consists essentially of from about 70% to about 80% nitrous oxide. In some embodiments, a composition consists of from about 10% to about 80% nitrous oxide and one or more inert compounds that are gases at a temperature range of from about 0° C. and about 25° C. and at atmospheric pressure. In some embodiments, the composition consists of from about 20% to about 80% nitrous oxide. In some embodiments, the composition consists of from about 30% to about 80% nitrous oxide. In some embodiments, the composition consists of from about 40% to about 80% nitrous oxide. In some embodiments, the composition consists of from about 50% to about 80% nitrous oxide. In some embodiments, the composition consists of from about 60% to about 80% nitrous oxide. In some embodiments, the composition consists of from about 70% to about 80% nitrous oxide. For example, the range of nitrous oxide present in the composition can be about 10-80%, 10-75%, 10-70%, 10-65%, 10-60%, 10-55%, 10-50%, 10-45%, 10-40%, 10-35%, 10-30%, 10-25%, 10-20%, 10-15%, 15-80%, 15-75%, 15-70%, 15-65%, 15-60%, 15-55%, 15-50%, 15-45%, 15-40%, 15-35%, 15-30%, 15-25%, 15-20%, 20-80%, 20-75%, 20-70%, 20-65%, 20-60%, 20-55%, 20-50%, 20-45%, 20-40%, 20-35%, 20-30%, 20-25%, 25-80%, 25-75%, 25-70%, 25-65%, 25-60%, 25-55%, 25-50%, 25-45%, 25-40%, 25-35%, 25-30%, 30-80%, 30-75%, 30-70%, 30-65%, 30-60%, 30-55%, 30-50%, 30-45%, 30-40%, 30-35%, 35-80%, 35-75%, 35-70%, 35-65%, 35-60%, 35-55%, 35-50%, 35-45%, 35-40%, 40-80%, 40-75%, 40-70%, 40-65%, 40-60%, 40-55%, 40-50%, 40-45%, 45-80%, 45-75%, 45-70%, 45-65%, 45-60%, 45-55%, 45-50%, 50-80%, 50-75%, 50-70%, 50-65%, 50-60%, 50-55%, 55-80%, 55-75%, 55-70%, 55-65%, 55-60%, 60-80%, 60-75%, 60-70%, 60-65%, 65-80%, 65-75%, 65-70%, 70-80%, 70-75%, or 75-80%. Exemplary amounts of nitrous oxide present in the composition can be about 10%, 15%, 20%, 25%, 30%, 35%, 40%, 45%, 50%, 55%, 60%, 65%, 70%, 75% or 80%.

In some embodiments, the one or more inert compounds is selected from: argon, helium, neon, krypton, xenon, nitrogen, and mixtures thereof. For example, the one or more inert compounds can include argon. In some embodiments, the one or more inert compounds consists essentially of argon. In some embodiments, the one or more inert compounds consists of argon. For example, the one or more inert compounds can include xenon. In some embodiments, the one or more inert compounds consists essentially of xenon. In some embodiments, the one or more inert compounds consists of xenon. The range of the one or more inert gases in the composition can be about 20-90%, 25-90%, 30-90%, 35-90%, 40-90%, 45-90%, 50-90%, 55-90%, 60-90%, 65-90%, 70-90%, 75-90%, 80-90%, 85-90%, 20-85%, 25-85%, 30-85%, 35-85%, 40-85%, 45-85%, 50-85%, 55-85%, 60-85%, 65-85%, 70-85%, 75-85%, 80-85%, 20-80%, 25-80%, 30-80%, 35-80%, 40-80%, 45-80%, 50-80%, 55-80%, 60-80%, 65-80%, 70-80%, 75-80%, 20-75%, 25-75%, 30-75%, 35-75%, 40-75%, 45-75%, 50-75%, 55-75%, 60-75%, 65-75%, 70-75%, 20-70%, 25-70%, 30-70%, 35-70%, 40-70%, 45-70%, 50-70%, 55-70%, 60-70%, 65-70%, 20-65%, 25-65%, 30-65%, 35-65%, 40-65%, 45-65%, 50-65%, 55-65%, 60-65%, 20-60%, 25-60%, 30-60%, 35-60%, 40-60%, 45-60%, 50-60%, 55-60%, 20-55%, 25-55%, 30-55%, 35-55%, 40-55%, 45-55%, 50-55%, 20-50%, 25-50%, 30-50%, 35-50%, 40-50%, 45-50%, 20-45%, 25-45%, 30-45%, 35-45%, 40-45%, 20-40%, 25-40%, 30-40%, 35-40%, 20-35%, 25-35%, 30-35%, 20-30%, 25-30%, or 20-25%. The one or more inert gases can be about 20%, 25%, 30%, 35%, 40%, 45%, 50%, 55%, 60%, 65%, 70%, 75%, 80%, 85% or 90% of the composition.

In some embodiments, the composition includes from about 40% to about 60% nitrous oxide by weight and one or more inert compounds selected from the group consisting of: argon, helium, neon, krypton, xenon, nitrogen, and mixtures thereof. In some embodiments, the composition consists essentially of from about 40% to about 60% nitrous oxide by weight and one or more inert compounds selected from the group consisting of: argon, helium, neon, krypton, xenon, nitrogen, and mixtures thereof. In some embodiments, the composition consists of from about 40% to about 60% nitrous oxide by weight and one or more inert compounds selected from the group consisting of: argon, helium, neon, krypton, xenon, nitrogen, and mixtures thereof. For example, the composition can include about 40%, 50%, or 60% nitrous oxide. In some embodiments, the one or more inert compounds includes argon. In some embodiments, the one or more inert compounds consists essentially of argon. In some embodiments, the one or more inert compounds consists of argon. In some embodiments, the one or more inert compounds includes xenon. In some embodiments, the one or more inert compounds consists essentially of xenon. In some embodiments, the one or more inert compounds consists of xenon.

In some embodiments, the composition includes about 50% nitrous oxide and about 50% argon by weight. In some embodiments, the composition consists essentially of about 50% nitrous oxide and about 50% argon by weight. In some embodiments, the composition consists of about 50% nitrous oxide and about 50% argon by weight.

In some embodiments, the composition includes about 50% nitrous oxide and about 50% xenon by weight. In some embodiments, the composition consists essentially of about 50% nitrous oxide and about 50% xenon by weight. In some embodiments, the composition consists of about 50% nitrous oxide and about 50% xenon by weight.

An aspect of the current disclosure describes a composition including from about 10% to about 80% nitrous oxide by weight and xenon. In some embodiments, the composition includes from about 20% to about 90% xenon. In some embodiments, the composition includes from about 20% to about 80% xenon. In some embodiments, the composition includes from about 30% to about 80% xenon. In some embodiments, the composition includes from about 40% to about 80% xenon. In some embodiments, the composition includes from about 50% to about 80% xenon. In some embodiments, the composition includes from about 60% to about 80% xenon. In some embodiments, the composition includes from about 70% to about 80% xenon. In some embodiments, the composition consists of from about 20% to about 80% xenon. In some embodiments, the composition consists of from about 30% to about 80% xenon. In some embodiments, the composition consists of from about 40% to about 80% xenon. In some embodiments, the composition consists of from about 50% to about 80% xenon. In some embodiments, the composition consists of from about 60% to about 80% xenon. In some embodiments, the composition consists of from about 70% to about 80% xenon.

In some embodiments, the range of xenon in the composition can be about 20-90%, 25-90%, 30-90%, 35-90%, 40-90%, 45-90%, 50-90%, 55-90%, 60-90%, 65-90%, 70-90%, 75-90%, 80-90%, 85-90%, 20-85%, 25-85%, 30-85%, 35-85%, 40-85%, 45-85%, 50-85%, 55-85%, 60-85%, 65-85%, 70-85%, 75-85%, 80-85%, 20-80%, 25-80%, 30-80%, 35-80%, 40-80%, 45-80%, 50-80%, 55-80%, 60-80%, 65-80%, 70-80%, 75-80%, 20-75%, 25-75%, 30-75%, 35-75%, 40-75%, 45-75%, 50-75%, 55-75%, 60-75%, 65-75%, 70-75%, 20-70%, 25-70%, 30-70%, 35-70%, 40-70%, 45-70%, 50-70%, 55-70%, 60-70%, 65-70%, 20-65%, 25-65%, 30-65%, 35-65%, 40-65%, 45-65%, 50-65%, 55-65%, 60-65%, 20-60%, 25-60%, 30-60%, 35-60%, 40-60%, 45-60%, 50-60%, 55-60%, 20-55%, 25-55%, 30-55%, 35-55%, 40-55%, 45-55%, 50-55%, 20-50%, 25-50%, 30-50%, 35-50%, 40-50%, 45-50%, 20-45%, 25-45%, 30-45%, 35-45%, 40-45%, 20-40%, 25-40%, 30-40%, 35-40%, 20-35%, 25-35%, 30-35%, 20-30%, 25-30%, or 20-25%. The xenon can be about 20%, 25%, 30%, 35%, 40%, 45%, 50%, 55%, 60%, 65%, 70%, 75%, 80%, 85% or 90% of the composition.

A typical example uses a composition that is food grade or better. In some embodiments, the composition is food grade.

Commonly food-grade gases are available from industrial gas suppliers that produce tank gases or filled gas cartridges for a number of industrial applications, such as for food preparation or for medical uses. Examples of industrial gas suppliers include Praxair Technology, Inc. (Danbury, Conn., USA), Air Products and Chemicals, Inc. (USA), and Airgas USA, LLC. Specialized gas suppliers that serve specific needs for the food preparation market can also be a source of food-grade gases. An example is Gruenewald Manufacturing Company, Inc. (Danvers, Mass., USA), which produces food-grade nitrous oxide gas.

In some embodiments, the composition is a pressurized composition. Such pressurized compositions may be formulated into, for example, compressed gas canisters or aerosol cans. In some embodiments, the pressurized composition can be at a pressure from about 1.5 bar to about 450 bar. In some embodiments, the pressurized composition can be at a pressure from about 1.5 bar to about 50 bar. In some embodiments, the pressurized composition can be at a pressure from about 50 bar to about 100 bar. In some embodiments, the pressurized composition can be at a pressure from about 100 bar to about 150 bar. In some embodiments, the pressurized composition can be at a pressure from about 150 bar to about 200 bar. In some embodiments, the pressurized composition can be at a pressure from about 200 bar to about 250 bar. In some embodiments, the pressurized composition can be at a pressure from about 250 bar to about 300 bar. In some embodiments, the pressurized composition can be at a pressure from about 300 bar to about 350 bar. In some embodiments, the pressurized composition can be at a pressure from about 350 bar to about 400 bar. In some embodiments, the pressurized composition can be at a pressure from about 400 bar to about 450 bar. Exemplary ranges of pressure in which the composition may be found include 1.5-20, 20-40, 40-60, 60-80, 80-100, 100-120, 120-140, 140-160, 160-180, 180-200, 200-220, 220-240, 240-260, 260-280, 280-300, 300-320, 320-340, 340-360, 360-380, 380-400, 400-420, 420-440, 1.5-30, 30-60, 60-90, 90-120, 120-150, 150-180, 180-210, 210-240, 240-270, 270-300, 300-330, 330-360, 360-390, 390-420, 420-450, 1.5-40, 40-80, 80-120, 120-160, 160-200, 200-240, 240-280, 280-320, 320-360, 360-400, 400-440, 1.5-50, 50-100, 100-150, 150-200, 200-250, 250-300, 300-350, 350-400, 400-450, 1.5-60, 60-120, 120-180, 180-240, 240-300, 300-360, 360-420, 1.5-70, 70-140, 140-210, 210-280, 280-350, 350-420, 1.5-100, 50-150, 100-200, 150-250, 200-300, 250-350, 300-400, and 350-450 bar. For example, the pressurized composition can be at 1.5, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, or 450 bar.

Under pressure, the compositions may include different phases of compounds that are gases at a temperature range of from about 0° C. to about 25° C. and at atmospheric pressure. In some embodiments, the mixture includes a liquid mixture. In some embodiments, the mixture includes a liquid/gas mixture. In some embodiments, the mixture includes a gas mixture.

Any of the compositions and methods described in the disclosure may be used in aerosol cans. The aerosol cans contain a pressurized gas or mixture (e.g. a liquid, liquid/gas, or gas mixture) and the food product being dispensed. Any of such described aerosol cans may be used to dispense the compositions or to operate the methods disclosed in the present application.

Disclosed herein are compositions which may be used in compressed gas cartridges and methods to be used with gas cartridges.

Shipping, transport, or storage of any composition, pressurized composition, or compressed gas cartridge including a composition of the present disclosure can be performed according to the safety requirements of the local jurisdiction, for example, according to the Material Safety Data Sheets of the Occupational Safety and Health Administration of the United States Department of Labor, and conform to the requirements for the individual components (e.g. nitrous oxide and argon).

### EXAMPLES

Weight measurements were performed on a Kamenstein digital scale Model 5105596. Pressure measurements were performed using an analog 0-300 psi (0-21 bar) pressure gauge. Volume measurements were made in graduated 1.0 L tempered glass kitchen measuring cups.

Nitrous oxide compressed gas was purchased and used from 8-g food-grade gas cartridges (C) or from a M-20 aluminum bulk tank (T) (nitrous oxide tank, 20 lb, food grade, 2500 psi from Gruenewald Manufacturing, Danvers, Mass., USA). Argon compressed gas (99.7% pure) was from a Praxair Size Q inert gas cylinder.

Whipped cream was dispensed from a 0.5 L stainless steel whip cream dispenser. Safeway Lucerne heavy whipping cream (8% butterfat content) or Costco Producer's Dairy heavy whipping cream (9% butterfat content) were purchased from local sources in northern California and were used without further modification. All examples below used Safeway source of cream, except for Examples #9 and #11, which used the Costco source.

Vanilla was purchased and used as is from Sonoma Syrup Company (vanilla bean extract “Crush”, 8 oz (236 mL)).

Nomenclature

Binary mixtures of nitrous oxide and an inert gas are named according to the following:

N-99=food-grade nitrous oxide, ≦1% inert gas (also known as E942)

N-70=70% nitrous oxide; 30% inert gas mixture

N-50=50% nitrous oxide; 50% inert gas mixture

N-20=20% nitrous oxide; 80% inert gas mixture

N-XX=XX % nitrous oxide; 100-XX % inert gas.

Determination of Nitrous Oxide Pressure in Full 8-g Cartridge

| | | |
|---|---|---|
| Water filled 8-g gas cartridge | 30 | grams |
| (weight) | | |
| Empty 8-g gas cartridge (weight) | 20 | grams |
| Water weight | 10 | grams |
| Water volume | 0.010 | L |

The volume of an 8-g gas cartridge was determined by comparing the weights of an empty gas cartridge to one filled with water. A commercial 8-g gas cartridge held up to 10 mL (0.010 L) water.

When full from a commercial source, the gas cartridge held 8 g of nitrous oxide, or 0.181 moles at 44 grams/mol. At 0° C. (273 K, the approximate temperature of a cold refrigerator), using the ideal gas equation: PV=nRT, wherein:

P=pressure; V=volume; n=number of moles of gas;

R=ideal gas constant (0.08206 L-atm/mol-K)

The resulting pressure was determined to be 407.3 atm (412.7 bar).

### Experimental Results

For all the examples shown below, the experiments were performed with 450 g heavy whipping cream with 5 g vanilla added in a stainless steel whip dispenser. The source of nitrous oxide (N₂O in Tables) was either from a compressed gas cylinder bulk tank (T) or from a commercial 8-g gas cartridge (C), and pressure was measured using an analog pressure regulator. Pressure was measured in psi (100 psi=6.89 bar=6.80 atm).

Protocol A: Determination of Whipped Volume of Cream with 99% Nitrous Oxide from a 8-g Gas Cartridge

To a clean, dry, pre-weighed stainless steel whip dispenser was added 450 g heavy whipping cream and 5 g vanilla. Total weight was determined of the apparatus with an empty 8-g gas cartridge (1226 grams), and with a full 8-g 99% nitrous oxide gas cartridge (1234 grams) using the digital scale. Heavy whipping cream and vanilla mixture was shaken to ensure uniformity. The whipped cream was then discharged slowly into one or more tempered glass kitchen measuring cups. The total cream discharged was measured upon full discharge (Time 0:00), after 1 hour incubation at room temperature (Time 1:00), and after 2 hours at room temperature (Time 2:00).

This general technique was employed in experiments that used only one type of gas.

Protocol B: Determination of Whipped Volume of Cream with 50% Nitrous Oxide

To a clean, dry, pre-weighed stainless steel whip dispenser was added 450 g heavy whipping cream and 5 g vanilla. Total weight was determined of the apparatus with an empty 8-g gas cartridge (1226 grams), and with a full 8-g 99% nitrous oxide gas cartridge (1234 grams) using the digital scale. Half (4 g) of the nitrous oxide gas was allowed to escape the stainless steel whip dispenser. Argon (4 g) from the commercial tank was added. Overall pressure in the whip dispenser was at about 200 psi. The heavy whipping cream and vanilla mixture was shaken to ensure uniformity. The whipped cream was then discharged slowly into one or more tempered glass kitchen measuring cups. The total cream discharged was measured upon full discharge (Time 0:00), after 1 hour incubation at room temperature (Time 1:00), and after 2 hours at room temperature (Time 2:00).

This general technique was employed in experiments when at least two gases were used.

TABLE 3

| | Example | | | |
|---|---|---|---|---|
| | #1 (N-99 C) | #2 (N-00) | #3 (N-99 T) | #4 (CO2-99) |
| Gas Mixture | N-99 | N-00 | N-99 | CO2-99 |
| N2O Source | gas cartridge | none | Comp Tank | none |
| N2O Amount (g) | 8 | 0 | 8 | 0 |
| Argon Source | none | Comp Tank | none | none |
| Argon Amount (g) | 0 | 8 | 0 | 0 |
| Other Comments: | Stiff whip cream | Formless, liquid | Refrig overnight | Acid taste |
| | Good volume | Whip cream | Stiff whip cream | effervescent |
| | | | Good volume | |
| Whip Cream Volume | | | | |
| (mL) | | | | |
| at Time 0:00 | 2,000 | 800 | 2,000 | 2,000 |
| at Time 1:00 | 1,600 | N/A | N/A | N/A |
| at Time 2:00 | 1,400 | N/A | N/A | N/A |
| at Time 3:00 | N/A | N/A | 1,500 | N/A |
| Whip Cream | 4.4 | 1.8 | 4.4 | 4.4 |
| Expansion Ratio at | | | | |
| Time 0:00 | | | | |
| Whip Cream | 432 | 444 | 432 | 442 |
| Dispensed Weight (g) | | | | |

Example #1 (Table 3) shows the results of discharged whipped cream using 99% nitrous oxide from an 8-g gas cartridge. Upon full discharge (Time 0:00), the cream was whipped up to 4.4 times the original volume of the cream, and a significant portion of the volume was retained for up to 2 hours after dispensing. This result was consistent regardless of the source of nitrous oxide (cartridge (C) or tank (T) as in Example #3).

Example #2 (Table 3) shows an expansion of whipped cream using 99% argon at 1.8 times the original volume of the cream. Example #8 (Table 3) confirmed this result.

Example #4 (Table 3) shows the results using 99% carbon dioxide (CO₂-99). While the formation and expansion of the whipped cream was comparable to that with 99% nitrous oxide, the carbon dioxide resulted in effervescent cream with an acidic flavor.

TABLE 2

| | Example | | |
|---|---|---|---|
| | #5 (N-50 T) | #6 (N-50 C) | #7 (N-50 C) |
| Gas Mixture | N-50 | N-50 | N-50 |
| N2O Source | Comp Tank | gas cartridge | gas cartridge |
| N2O Amount (g) | 4 | 4 | 4 |
| Argon Source | Comp Tank | Comp Tank | Comp Tank |
| Argon Amount (g) | 4 | 4 | 4 |
| Other Comments: | N/A | Good volume | N/A |
| Whip Cream Volume | | | |
| (mL) | | | |
| at Time 0:00 | 1,000 | 2,000 | 2,050 |
| at Time 1:00 | 950 | 1,700 | N/A |
| at Time 2:00 | 950 | 1,500 | 1,500 |
| Whip Cream | 2.2 | 4.4 | 4.5 |
| Expansion Ratio at | | | |
| Time 0:00 | | | |
| Whip Cream | 444 | 434 | 428 |
| Dispensed Weight (g) | | | |

An initial experiment, Example #5 (Table 4), with gases both from compressed gas tanks shows that the N-50 mixture gave an expansion ratio of 2.2. A compressed gas tank can be larger than 100 cc, and can contain a gas regulator device to dispense bulk gas at a given pressure. A compressed gas cartridge can be smaller than 100 cc, and can be sealed with a weld, a crimp or a valve, that dispenses the entire contents of the cartridge at one time.

Example #6 (Table 4) shows that with 99% nitrous oxide from an 8-g gas cartridge and 99% argon from a compressed gas tank, a whip cream expansion ratio of 4.4 was obtained, comparable to that observed in Example #1 for 99% nitrous oxide from an 8-g gas cartridge alone. Other trials of the N-50 composition (Examples #7 and #9) show an expansion ratio of 4.4 and 3.5, respectively. One non-limiting hypothesis for the difference between the nitrous oxide from the cartridge and the tank may be that the cartridge allows for a more rapid equilibrium to be established.

Example #10 (Table 5) shows the results of a trial with 30% nitrous oxide. The expansion ratio of the whipped cream was 3.1.

Example #11 (Table 5) shows the results with 70% nitrous oxide. The whipped cream expansion ratio was 3.3. Refrigeration of the cream and gas mixture overnight within the stainless steel dispenser appeared to facilitate equilibrium formation.

Examples #9 and #11 used a different source of cream which may explain some of the results that differed from the other trials.

### Model for Nitrous Oxide Use in the Aeration of Food

An Expansion-Propellant hypothesis serves as a model to explain the physical and chemical properties of nitrous oxide when used in the aeration of food, for example, to generate whipped cream. Nitrous oxide used in the production of whipped cream is believed to serve at least two functions:

1) When the release valve of the pressure vessel containing the nitrous oxide under pressure and the liquid cream is activated, the nitrous oxide under pressure serves as a propellant to move the liquid cream out of the pressure vessel.

2) When the release valve of the pressure vessel containing the nitrous oxide under pressure and the liquid cream is activated, the nitrous oxide dissolved in the liquid cream under pressure comes out of solution causing a rapid expansion of and setting of the liquid cream, thereby producing a whipped cream effect.

TABLE 5

| | Example | | | |
|---|---|---|---|---|
| | #8 (N-00) | #9 (N-50 C) | #10 (N-30 C) | #11 (N-70 T) |
| Gas Mixture | N-00 | N-50 | N-30 | N-70 |
| N2O Source | none | gas cartridge | gas cartridge | Comp Tank |
| N2O Amount (g) | 0 | 4 | 2.5 | 6 |
| Argon Source | Comp Tank | Comp Tank | Comp Tank | Comp Tank |
| Argon Amount (g) | 8 | 4 | 5.5 | 2 |
| Other Comments: | N/A | N/A | N/A | Refrig overnight |
| Whip Cream Volume | | | | |
| (mL) | | | | |
| at Time 0:00 | 800 | 1,600 | 1,400 | 1,500 |
| at Time 1:00 | 700 | 1,400 | 1,200 | 1,300 |
| at Time 2:00 | N/A | N/A | N/A | N/A |
| Whip Cream | 1.8 | 3.5 | 3.1 | 3.3 |
| Expansion Ratio at | | | | |
| Time 0:00 | | | | |
| Whip Cream | 442 | 440 | 428 | 432 |
| Dispensed Weight (g) | | | | |

### Method Using Two Gas Cartridges

Two partially charged compressed gas cartridges can be used instead of one fully charged 8-g nitrous oxide compressed gas cartridge to generate a composition of the present disclosure within a device, such as a stainless steel whip dispenser, used to create an aerated food product.

Typical compressed gas cartridges have the following characteristics: 10 cc volume, 20 gram weight, 2.5 inch length with 0.75 inch diameter, steel-walled cartridge, with a pierceable plug. Exemplary gas cartridges include nitrous oxide, nitrogen, and argon cartridges, which can be filled according to the following:

Compressed Gas Cartridges:

8-gram filled cartridge, total weight=28 gram

6-gram filled cartridge, total weight=26 gram

4-gram filled cartridge, total weight=24 gram

2-gram filled cartridge, total weight=22 gram

A number of compositions can be formulated using two compressed gas cartridges with varying amounts present to generate a fully charged stainless steel whip dispenser. For example, 450 g of heavy whipping cream and 5 g of vanilla is added to a 0.5 L stainless steel whip dispenser, charged with a 4-gram nitrous oxide compressed gas cartridge, followed by a second charge with a 4-gram argon compressed gas cartridge. The resulting gas composition within the dispenser includes about 50% nitrous oxide and about 50% argon, and the dispensed whipped cream affords a whipped effect created by such a composition. Similarly, 450 g of coconut milk is added to a 0.5 L stainless steel whip dispenser, charged with a 6-gram nitrous oxide compressed gas cartridge, followed by a second charge with a 2-gram argon compressed gas cartridge. The resulting gas composition within the dispenser includes about 75% nitrous oxide and about 25% argon, and the dispensed whipped coconut milk affords a whipped effect created by such a composition.

Thus the replacement of the function of nitrous oxide by another inert gas in its capacity in propelling or expanding the cream, or a combination of the two, would preserve utility while reducing nitrous oxide emissions with equivalent use.

Unless defined otherwise, all technical and scientific terms used herein have the same meaning as is commonly understood by one of ordinary skill in the art to which this disclosure belongs. All patents, applications, published applications, and other publications are incorporated by reference in their entirety. In the event that there is a plurality of definitions for a term herein, those in this section prevail unless stated otherwise.

For the terms “for example” and “such as” and grammatical equivalences thereof, the phrase “and without limitation” is understood to follow unless explicitly stated otherwise. As used herein, the term “about” is meant to account for variations due to experimental error. All measurements reported herein are understood to be modified by the term “about”, whether or not the term is explicitly used, unless explicitly stated otherwise. As used herein, the singular forms “a,” “an,” and “the” include plural referents unless the context clearly dictates otherwise.

“Atmospheric pressure” as used herein refers to ambient pressure of about 1 atmosphere (atm), or about 1 bar.

“Room temperature” as used herein is about 25° C.

All percentages (%) are by weight unless indicated otherwise in a specific circumstance.

It is to be understood that while the disclosure is read in conjunction with the detailed description thereof, the foregoing description is intended to illustrate and not limit the scope of the disclosure, which is defined by the scope of the appended claims. Other aspects, advantages, and modifications are within the scope of the following claims.

1. A container comprising pressurized gas, the container comprising:
a liquid substance;
a first gas dissolved in the liquid substance; and
a noble gas, wherein:
the first gas increases a volume of the liquid substance when the liquid substance is dispensed from the container,
a total weight of the first gas within the container is between 0.1 to 9 times that of the noble gas; and
a pressurized atmosphere within the container comprises less than 10% by weight of the first gas.

2. The container of claim 1, wherein the liquid substance comprises a diary product, and the first gas comprises nitrous oxide.

3. The container of claim 2, wherein the dairy product comprising cream and the noble gas comprises argon.

4. The container of claim 1, wherein the pressurized gas within the container has a pressure that is between 100 to 300 psi.

5. The container of claim 1, wherein the noble gas comprises xenon.

6. A container comprising pressurized gas, the container comprising:
an outlet;
a liquid substance;
a first gas dissolved in the liquid substance; and
a noble gas, wherein
the liquid substance and the first gas are dispensed from the outlet when the container is oriented in a first position, and
at least 90% of gas that is dispensed from the outlet when the container is oriented in a second position comprises the noble gas.

7. The container of claim 6, wherein the first position is an inverted position and the second position is an upright position.

8. The container of claim 6, wherein a pressurized atmosphere within the container comprises less than 10% by weight of the first gas.

9. The container of claim 6, wherein the liquid substance comprises cream, the first gas comprises nitrous oxide and the noble gas comprises argon.

10. A method of producing a pressurized container, the method comprising:
introducing a liquid substance into the container;
introducing a first gas into the container, the first gas dissolving in the liquid substance;
introducing a noble gas into the container;
providing an outlet to the container from which the liquid substance, the first gas, or the noble gas can be dispensed; and
sealing the container to maintain a pressure of between 100 to 300 psi inside the container; wherein:
the first gas increases a volume of the liquid substance upon dispensing of the liquid substance from the container;
a total weight of the first gas within the container is between 0.1 to 9 times that of the noble gas; and
a pressurized atmosphere within the container comprises less than 10% by weight of the first gas.

11. The method of claim 10, wherein the liquid substance comprises cream, the first gas comprises nitrous oxide, and the noble gas comprises argon.

12. The method of claim 11, wherein at least 90% of gas that is dispensed from the outlet when the pressurized container is oriented in a second position comprises argon.

13. A gas cartridge, comprising:
a mixture of nitrous oxide and a noble gas; and
an outlet of the gas cartridge is configured to engage with a receiving port of a pressurized dispenser,
wherein
the mixture has a pressure of between 600 to 3000 psi within the gas cartridge, the gas cartridge having a capacity of less than 100 cubic centimeter (cc), and the pressurized dispenser is configured to contain a liquid substance in which nitrous oxide dissolves.

13. The gas cartridge of claim 13, wherein the outlet is non-sealable.

14. The gas cartridge of claim 13, wherein the outlet is sealable.

15. The gas cartridge of claim 13, wherein the mixture comprises 50% argon and 50% nitrous oxide.

16. The gas cartridge of claim 13, wherein the noble gas comprises xenon.

17. An assembly, comprising:
the gas cartridge of claim 13, and
the pressurized dispenser, wherein
a pressure within the pressurized dispenser is between 100-300 psi after the mixture is released from the gas cartridge into the pressurized dispenser.

18. The assembly of claim 17, wherein the nitrous oxide from the mixture dissolves in the liquid substance and a pressurized atmosphere within the pressurizer dispenser comprises less than 10% by weight of nitrous oxide.

19. The assembly of claim 17, wherein the mixture comprises a food grade mixture.

20. A method of using the assembly of claim 17 to aerate the liquid substance, the liquid substance comprises a food product and the food product is aerated to a first volume that is within 50% of a volume of an aerated product that has been aerated with a 99% nitrous oxide gas composition.
